(19) United States
(12) Patent Application Publication
(10) Pub. No.: US 2013/0115859 A1
(43) Pub. Date: May 9, 2013

(54) SURFACE TREATMENT METHOD OF POLISHING PAD AND POLISHING METHOD OF WAFER USING THE SAME

(71) Applicants: Se Hun Choi, Incheon (KR); Kyeong Soon Kim, Daejeon (KR); Young Hee Mun, Daegu (KR)

(72) Inventors: Se Hun Choi, Incheon (KR); Kyeong Soon Kim, Daejeon (KR); Young Hee Mun, Daegu (KR)

(21) Appl. No.: 13/669,028

(22) Filed: Nov. 5, 2012

(30) Foreign Application Priority Data
Nov. 7, 2011 (KR) 10-2011-0114891

(51) Int. Cl. B24B 37/04; B28D 5/00

(52) U.S. Cl. CPC B24B 37/042; B24B 37/044; B28D 5/00
USPC 451/36

(57) ABSTRACT

Provided is a surface treatment method of a polishing pad. The surface treatment method of the polishing pad includes locating a wafer on the polishing pad including a polishing material, supplying a polishing pad polishing material between the polishing pad and the wafer to expose the polishing material included in the polishing pad, and polishing the wafer using the exposed polishing material.

### CROSS-REFERENCE TO RELATED APPLICATIONS

The present application claims priority under 35 U.S.C. 119 and 35 U.S.C. 365 to Korean Patent Application No. 10-2011-0114891 (filed on Nov. 7, 2011), which is hereby incorporated by reference in its entirety.

### BACKGROUND

Embodiments relate to a surface treatment method of a polishing pad and a polishing method of a wafer using the same.

Recently, GaN-based LEDs are being used in various fields such as high brightness white LEDs for lighting, LCD backlight units, signals, backlight light sources for TFT-LCD, backlight light sources for portable terminal, and keypads.

In the manufacture of LEDs, a sapphire wafer on which a semiconductor epitaxial layer is formed using a GaN-based compound such as GaN or GaAlN is used as an essential material. To use a sapphire wafer, a polishing process should be performed generally.

However, a general mechanical polishing process may cause surface defects because residual stress remains on a polished sapphire wafer. Thus, polishing scratches, micro cracks, or defects may be distributed on a surface of the polished wafer to exert a bad influence on thin film growth. That is, when a nitride semiconductor thin film is grown on the surface of the wafer, a crystal structure may be twisted and a high dislocation density may be generated due to the mechanical stress. Thus, when LEDs are manufactured, the mechanical stress may have a bad influence on brightness, light emitting efficiency, or life cycle of the LEDs.

The most sapphire wafers coming now into the market are manufactured through a process route as shown in FIG. 1. First, in operation S1, a sapphire ingot processed in a circular shape with a diameter equal to that of a substrate is sliced using a diamond wire, or a substrate grown in a plate shape is circularly sliced in a diameter direction thereof. Then, in operation S2, a double-side lapping process is performed on a surface of the wafer to remove wire marks and wafer warpage which occur due to a thickness variation or during the slicing. In operation S3, a wafer chamfering process is performed to remove a sharp portion of an edge of the wafer.

Next, in operation S4, the wafer adheres to a ceramic block using wax to achieve planarization and polishing of the sapphire wafer. The wafer attached to the ceramic block is closely attached to a metal plate by an air pressure.

Thereafter, a diamond mechanical polishing (DMP) process is performed to remove the surface roughness and stress which are generated during the lapping. The DMP process may be generally performed in two stages. In the first stage (S5), the DMP process is performed for about 1 hour to about 2 hours using diamond particles having a size of about 3 μm to about 10 μm to remove the lapping scratches. Sequentially, in the second stage (S6), the residual scratches and the damages due to the first stage are removed using diamond particles having a size of about 0.5 μm to about 3 μm to achieve uniform planarization. Here, after the CMP process is performed, scratch defects may occur by the diamond particles stuck in the soft metal plate.

Finally, a chemical mechanical polishing (CMP) process for surface glossing of the wafer is performed using a polishing pad and slurry in operation S7 to atomically planarize roughness of the mechanically polished surface. The surface of the sapphire wafer manufactured through the above-described processes should have planarization required for a device.

However, in the above-described polishing method according to a related art, it is necessary to manage the plate in shape due to the sapphire wafer having high hardness. Also, equipment productivity may be reduced due to frequent replacement of the plate. In addition, there are limitations that deformation of the metal plate due to the use of the diamond slurry, a nonuniform polishing rate, and difficulty in the planarization control may occur.

### SUMMARY

Embodiments provide a method in which a polishing material included in a polishing pad is exposed using a polishing pad polishing material to polish a wafer using the exposed polishing material.

In one embodiment, a surface treatment method of a polishing pad includes: locating a wafer on the polishing pad including a polishing material; supplying a polishing pad polishing material between the polishing pad and the wafer to expose the polishing material included in the polishing pad; and polishing the wafer using the exposed polishing material.

In another embodiment, a polishing method of a wafer includes: supplying a polishing pad polishing material on a first polishing pad including a first diamond particle to perform a first polishing process on a wafer; supplying the polishing pad polishing material on a second polishing pad including a second diamond particle to perform a second polishing process on the wafer in which the first polishing process is performed; performing a third polishing process in which the wafer where the second polishing process is performed is chemically and mechanically polished using a stock pad; and performing a fourth polishing process in which the wafer where the third polishing process is performed is chemically and mechanically polished using a final pad which is softer than that of the stock pad.

The details of one or more embodiments are set forth in the accompanying drawings and the description below. Other features will be apparent from the description and drawings, and from the claims.

### BRIEF DESCRIPTION OF THE DRAWINGS

FIG. 1 is a flowchart illustrating a polishing process of a sapphire wafer according to a related art.

FIG. 2 is a flowchart illustrating a surface treatment method of a polishing pad according to an embodiment.

FIG. 3 is a photograph illustrating a top surface of a polishing pad including a polishing material according to an embodiment.

FIG. 4 is a flowchart illustrating a polishing method of a sapphire wafer according to an embodiment.

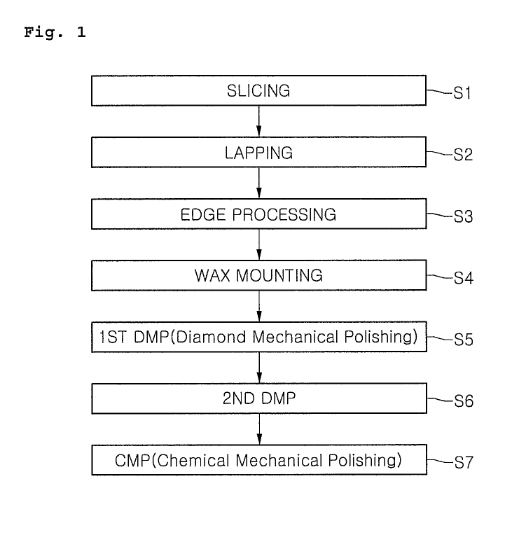

### DETAILED DESCRIPTION OF THE EMBODIMENTS

In the description of embodiments, it will be understood that when each plate, pad, wafer, or layer is referred to as being ‘on’ or ‘under’ another plate, pad, wafer, or layer, the terminology of ‘on’ and ‘under’ includes both the meanings of ‘directly’ and ‘indirectly’. Further, the reference about ‘on’ and ‘under’ each component layer will be made on the basis of drawings. In addition, the sizes of elements and the relative sizes between elements may be exaggerated for further understanding of the present disclosure.

A term “wafer” used in this specification may be included without specific limitations if the wafer is manufactured using a material ordinarily used in the art. In more detail, a term “wafer” used in this specification may include a “sapphire wafer”, but is not limited thereto.

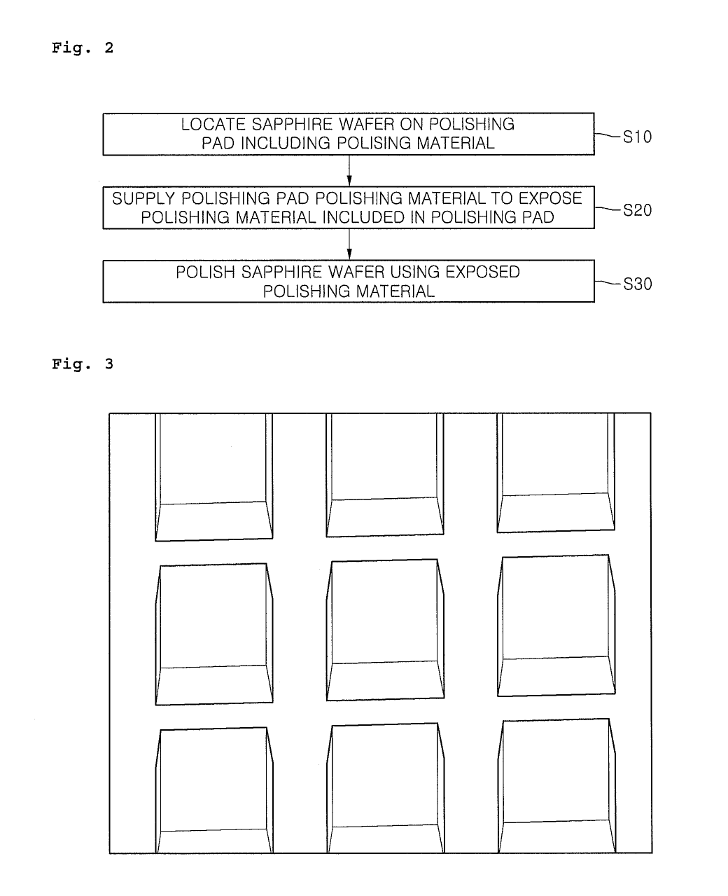

FIG. 2 is a flowchart illustrating a surface treatment method of a polishing pad according to an embodiment.

Referring to FIG. 2, a surface treatment method of a polishing pad according to an embodiment includes: locating a wafer on the polishing pad including a polishing material (S10); supplying a polishing pad polishing material between the polishing pad and the wafer to expose the polishing material included in the polishing pad (S20); and polishing the wafer using the exposed polishing material (S30).

The polishing pad according to the current embodiment includes the polishing material. Thus, in the current embodiment, it may be unnecessary to supply slurry including a polishing material on a metal plate. According to a related art, a metal plate coated with slurry including a polishing material may be deformed in shape due to friction with a wafer during the processing. Thus, it may be difficult to control planarization due to a nonuniform polishing rate and a change of polished amount by nonuniform coating of slurry. Also, slurry and foreign substances may be penetrated into processing defect portions on the polished surface of a sapphire wafer to affect final particle quality.

On the other hand, according to the current embodiment, the polishing material may be fixed to the polishing pad to easily control the polishing material, thereby easily controlling the polished amount and planarization.

The polishing pad including the polishing material may be manufactured by dispersing and mixing a high-hardness polishing material and elastic polymer particles in a spraying method.

As necessary, a process for forming the dispersed and mixed polishing material-polymer composite dispersion again in a predetermined shape may be additionally performed to improve a bonding force between the polishing material and the polymer. Alternatively, slurry including a polishing material and a coupling agent precursor may be manufactured, and then, the slurry may be cured and solidified to manufacture a polishing pad including the polishing material. The coupling agent may be derived from the coupling agent precursor including an organic polymer. Also, the coupling agent may be a curable condensation polymer or an addition polymer, but is not limited thereto.

The polishing material may not be specifically limited if the polishing material is a hard material capable of polishing the sapphire wafer and is ordinarily used in the art. For example, the polishing material may be particles formed of a compound selected from the group consisting of cesium, aluminum, silicon, zirconium oxide particles, silicon carbide compound, boron nitride, diamond, and combination thereof, but is not limited thereto. For example, the polishing material may be diamond particles.

The polishing material may have a mean particle size of about 1 μm to about 100 μm. The particle size of the polishing material may be adjusted according to a removal amount of the sapphire wafer. For example, the polishing material may have a mean particle size of about 10 μm to about 30 μm or about 1 μm to about 10 μm, but is not limited thereto.

The polishing material may be disposed on a top surface of the polishing pad or disposed inside the polishing pad. In more detail, the polishing material may be disposed inside the polishing pad and fixed by the polishing pad. For example, the polishing material included in the polishing pad may have a content gradually increased adjacent to the top surface of the polishing pad. As described above, when the polishing material is disposed adjacent to the top surface of the polishing pad, the polishing material may be more easily exposed by removing the polishing pad (this process will be described later).

Also, the top surface of the polishing pad may be patterned. Due to the patterned top surface of the polishing pad, remnants generated during the polishing may be efficiently removed from the polishing surface. For example, the remnants may be a polished material of the wafer worn during the polishing, the polishing material and polishing pad removed during the polishing, or the pad polishing material supplied for polishing the pad.

Here, the patterned shape is not specifically limited if the patterned shape has a shape enough to remove the remnants generated during the polishing from the outside. For example, the top surface of the polishing pad may include a protrusion structure. As shown in FIG. 3, a plurality of patterns, each having a square shape, may be disposed to form a tile shape. The tile shape represents a shape in which tiles having square shapes are successively arranged in vertical and horizontal directions with a preset distance.

Also, at least one pattern protruding in a ring shape, except for the square shape, when viewed in plan may be formed on the top surface of the polishing pad. Alternatively, at least one pattern protruding in a spiral shape may be formed on the top surface of the polishing pad.

In operation S10, a predetermined pressure is applied to the polishing material exposed to the top surface of the polishing pad and the sapphire wafer to rotate the polishing material and the sapphire wafer, thereby polishing the sapphire wafer. Here, the polishing pad and the sapphire wafer may be rotated in the same direction or in directions opposite to each other. When the polishing process is performed, the polishing material exposed to the top surface of the polishing pad may be worn.

While the polishing process is performed, the polishing pad polishing material is supplied between the polishing pad and the sapphire wafer. The polishing pad polishing material may be successively removed inward from a surface of the polishing pad. Thus, in operation S20, the non-worn polishing material disposed inside the polishing pad may be exposed to the outside. That is, according to the surface treatment method of the polishing pad, the polishing material disposed inside the polishing pad may be exposed through the above-described methods to polish the sapphire wafer, thereby maintaining and adjusting a polishing rate.

Also, since the polishing pad polishing material mechanically removes only the polishing pad, unlike an alkaline polishing material according to the related art, the polishing pad polishing material may easily remove the polishing pad even though a small amount of polishing pad polishing material is supplied. For example, the polishing pad polishing material may be supplied at a rate of about 0.5 l/min to about 1 l/min.

The polishing pad polishing material may not be specifically limited if the polishing pad polishing material has hardness greater than that of the polishing pad and can easily remove the polishing pad. For example, the polishing pad polishing material may include aluminum oxide, cesium oxide, or silicon oxide. In more detail, the polishing pad polishing material may be a solution or colloid including aluminum oxide (alumina) particles, cesium oxide particles, or silicon oxide particles. For example, the solution may a solution containing sodium carbonate (Na₂CO₃) compound, potassium compound, or tetramethyl armmonium hydroxide (TMAH) compound. Also, the polishing pad polishing material may be colloidally dispersed silica. Also, the polishing pad polishing material may have a flow rate of about 100/min to about 1,000/min.

Finally, in operation S30, a process of polishing the sapphire wafer using the exposed polishing material is performed. The damaged layer on the surface of the sapphire wafer may be removed as if to be scratched by a rotation friction force of the exposed polishing material fixed to the polishing pad. Thus, the surface of the sapphire wafer formed through the above-described processes may be scratched at a very thin depth. As a result, the processing damaged layer on the surface of the wafer may be reduced to improve uniformity of the polished amount and planarization.

Although the operation S10 and the operation S30 are separately performed in the foregoing method, this is merely an example for convenience of description, and thus the present disclosure is not limited thereto. That is, the operation S10 and the operation S30 may be performed at the same time.

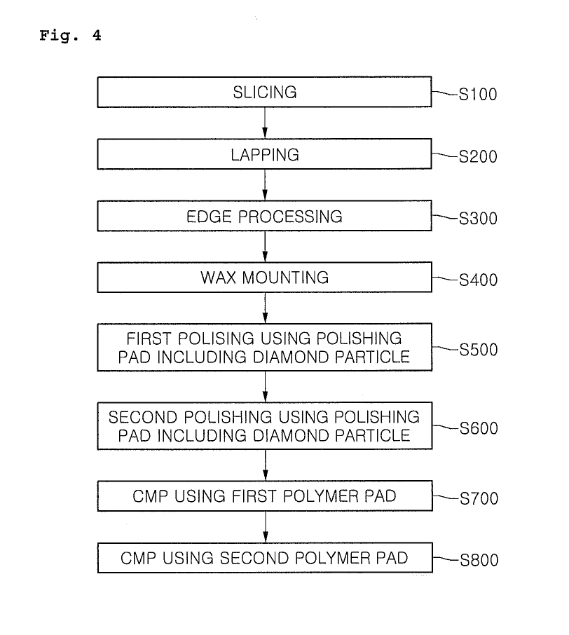

FIG. 4 is a flowchart illustrating a polishing method of a wafer according to an embodiment.

A polishing method according to the current embodiment may be described with reference to the above-described surface treatment method of the polishing pad. That is, the descriptions with respect to the above-described surface treatment method of the polishing pad may be essentially coupled to descriptions with respect to a manufacturing method according to the current embodiment.

In a polishing method of a wafer according to the current embodiment, the wafer may be easily polished using the above-described surface treatment method of the polishing pad. In more detail, referring to FIG. 4, the polishing method according to the current embodiment includes: supplying a polishing pad polishing material on a first polishing pad including a first diamond particle to perform a first polishing process on a wafer (S500); supplying the polishing pad polishing material on a second polishing pad including a second diamond particle having a size less than that of the first diamond particle to perform a second polishing process on the wafer in which the first polishing process is performed (S600); performing a third polishing process (S700) in which the wafer where the second polishing process is performed is chemically and mechanically polished using a stock pad; and performing a fourth polishing process (S800) in which the wafer where the third polishing process is performed is chemically and mechanically polished using a final pad which is softer than that of the stock pad.

First, after a slicing process (S100) and a lapping process (S200) are performed, an edge of a cleaned wafer is processed in operation S300. Thereafter, in operation S400, a wax adhesion process is performed on a ceramic plate to remove a thickness variation. The sapphire wafer adhering to the ceramic plate is transferred by a robot arm, is upside down within a loading elevator, and is on standby for polishing.

Sequentially, in operations S500 and S600, a polishing process of a polishing pad including the diamond particle is performed. The polishing process of the polishing pad including the diamond particle may be performed once or repeatedly performed several times. Although the polishing process of the polishing pad including the diamond particle is performed in two stages in FIG. 4, the present disclosure is not limited thereto. For example, the polishing process may be performed once or in three stages or more as necessary.

The diamond particles used in the first and second polishing processes (S500 and S600) using the polishing pad may have sizes different from each other. That is, the second diamond particle may have a mean size less than that of the first diamond particle. For example, the first diamond particle may have a mean size of about 10 μm to about 30 μm, and the second diamond particle may have a mean size of about 1 μm to about 10 μm. As described above, each of the diamond particles may be adjusted in size to decide a polishing rate.

As described above, a polishing material having a slurry form is not supplied in the first and second polishing processes (S500 and S600). That is, the polishing processes (S500 and S600) may be performed using the polishing pad including the polishing material. That is, according to the current embodiment, the polishing process may be easily performed without using the slurry including the polishing material to improve the nonuniform polishing rate and planarization control. Also, slurry adhesion and substrate contamination due to the slurry adhesion may be solved.

Although only a single surface of the sapphire wafer is polished in the first and second polishing processes, the present disclosure is not limited thereto. That is, each of the first and second polishing processes may include a double side polishing (DSP) process for polishing both side surfaces of the sapphire wafer.

After the polishing process of the polishing pad including the diamond particle is performed, a chemical and mechanical polishing process may be performed in operations S700 and S800. The chemical and mechanical polishing process may be a chemical mechanical polishing (CMP) process. Also, the chemical and mechanical polishing process may be performed once or in two stages or more. In more detail, the chemical and mechanical polishing process may include the third polishing process (S700) using the stock pad and the fourth polishing process (S800) using a final pad which is softer than that of the stock pad.

The stock pad used in the third polishing process (S700) may include a soft pad in which polyurethane is immersed into non-woven polyester felt tissues. Also, stock slurry is supplied between the stock pad and the wafer in the third polishing process (S700). The stock slurry may include slurry for removing silica or alumina slurry. For example, a polishing material contained in the stock slurry may have a mean particle sized of about 10 nm to about 17 nm, but is not limited thereto.

For example, the third polishing process (S700) may include a process in which colloidally dispersed silica slurry or alumina slurry are sprayed onto a polishing device (see FIG. 2) to which the polyurethane polishing pad is attached to press a ceramic block and rotate the final pad and the block, thereby performing the polishing process. Here, the third polishing process may be performed with a removal amount of about 5 μm or less.

After the third polishing process (S700) is performed, the fourth polishing process (S800) may be additionally performed to control the final roughness of the wafer and LLS.

The final pad may be used in the fourth polishing process (S800). The final pad may be softer than that of the stock pad used in the third polishing process (S700). Also, final slurry is supplied between the final pad and the wafer in the fourth polishing process (S800). The final slurry may include slurry containing a colloidal silica polishing material. Also, the polishing material contained in the final slurry may have a mean particle size of about 30 nm to about 40 nm, but is not limited thereto.

For example, in the fourth polishing process, a polishing process may be additionally performed while a predetermined pressure per each ceramic block is applied to a single side polishing device to which a polytex-based polishing pad is attached.

In the surface treatment method of the polishing pad according to the embodiment, the polishing material included in the polishing pad may be exposed using the polishing pad polishing material to polish the wafer using the exposed polishing material. Thus, according to the embodiment, the polishing process may be easily performed without using the slurry including the polishing material to adjust the polishing rate and improve the nonuniform removal amount of the wafer and planarization control. Also, the slurry adhesion and the substrate contamination due to the slurry adhesion may be solved.

Since the present disclosure can be applied to technologies for polishing a wafer, industrial applicability may be significantly high.

A particular feature, structure, or effects described in connection with the embodiment is included in at least one embodiment of the invention, and is not limited to only one embodiment. Further, when a particular feature, structure, or characteristic is described in connection with any embodiment, it is submitted that it is within the purview of one skilled in the art to effect such feature, structure, or characteristic in connection with other ones of the embodiments. Therefore, contents with respect to various variations and modifications will be construed as being included in the scope of the present disclosure.

What is claimed is:

1. A surface treatment method of a polishing pad, the surface treatment method comprising:
locating a wafer on the polishing pad comprising a polishing material;
supplying a polishing pad polishing material between the polishing pad and the wafer to expose the polishing material comprised in the polishing pad; and
polishing the wafer using the exposed polishing material.

2. The surface treatment method according to claim 1, wherein the polishing material comprises a particle formed of a compound selected from the group consisting of cesium, aluminum, silicon, zirconium oxide particles, silicon carbide compound, boron nitride, diamond, and combination thereof.

3. The surface treatment method according to claim 1, wherein the polishing pad polishing material comprises at least one of aluminum oxide, cesium oxide, or silicon oxide.

4. The surface treatment method according to claim 1, wherein the polishing pad has a patterned top surface.

5. The surface treatment method according to claim 4, wherein at least one square-shaped pattern, ring-shaped pattern, or spiral-shaped pattern is formed on the top surface of the polishing pad.

6. A polishing method of a wafer, the polishing method comprising:
supplying a polishing pad polishing material on a first polishing pad comprising a first diamond particle to perform a first polishing process on a wafer;
supplying the polishing pad polishing material on a second polishing pad comprising a second diamond particle to perform a second polishing process on the wafer in which the first polishing process is performed;
performing a third polishing process in which the wafer where the second polishing process is performed is chemically and mechanically polished using a stock pad; and
performing a fourth polishing process in which the wafer where the third polishing process is performed is chemically and mechanically polished using a final pad which is softer than that of the stock pad.

7. The polishing method according to claim 6, wherein the first polishing process comprises:
locating the wafer on the first polishing pad comprising a polishing material;
supplying the polishing pad polishing material between the first polishing pad and the wafer to expose the first diamond particle comprised within the polishing pad;
polishing the wafer using the exposed first diamond particle.

8. The polishing method according to claim 6, wherein the second polishing process comprises:
locating the wafer on the second polishing pad comprising a polishing material;
supplying the polishing pad polishing material between the second polishing pad and the wafer to expose the second diamond particle comprised within the polishing pad;
polishing the wafer using the exposed second diamond particle.

9. The polishing method according to claim 6, wherein at least one square-shaped pattern, ring-shaped pattern, or spiral-shaped pattern is formed on a top surface of the first or second polishing pad.

10. The polishing method according to claim 6, wherein the first diamond particle has a mean size of about 10 μm to about 30 μm, and the second diamond particle has a mean size of about 1 μm to about 10 μm.

11. The polishing method according to claim 6, further comprising cleaning the wafer before the first polishing process is performed on the wafer,
wherein the cleaning of the wafer comprises:
slicing and lapping the wafer;
processing an edge of the wafer; and
performing a wax adhesion process on the wafer to adhere to a ceramic plate.
